(19) United States
(12) Patent Application Publication
(10) Pub. No.: US 2014/0358702 A1
(43) Pub. Date: Dec. 4, 2014

(54) Institutional Catering Business Method and Associated Website

(71) Applicants: Justin Gagnon, San Ramon, CA (US); Ryan Mariotti, San Ramon, CA (US); Keith Cosbey, San Ramon, CA (US)

(72) Inventors: Justin Gagnon, San Ramon, CA (US); Ryan Mariotti, San Ramon, CA (US); Keith Cosbey, San Ramon, CA (US)

(21) Appl. No.: 13/947,047

(22) Filed: Jul. 20, 2013

Related U.S. Application Data
(60) Provisional application No. 61/830,158, filed on Jun. 2, 2013.

(51) Int. Cl. G06Q 30/06; G06Q 50/12

(52) U.S. Cl. CPC G06Q 30/0633; G06Q 50/12
USPC 705/15

(57) ABSTRACT

The present disclosure relates to a catering business that utilizes a website to manage individual food orders that are processed at one or more production kitchens strategically located near the target market. The catering business manages the production of food items, the delivery of food items that can be maintained in portable ovens or warmers and/or active cooling, passive insulated or non-insulated containers that preserve the food items for subsequent consumption. The catering business delivers the food items to various institutional locations for distribution by the particular institution. The delivery of food items can be for breakfast, lunch and/or dinner meals. After the food is consumed, the delivery vehicles can return to the institutions to recover the portable ovens or warmers and/or active cooling, passive insulated or non-insulated containers.

### RELATED APPLICATIONS

The present application is a non-provisional application of provisional application No. 61/830,158 filed on Jun. 2, 2013 and entitled Institutional Catering Business Method and Associated Website. This Provisional Applications is incorporated herein by this reference

### FIELD OF INVENTION

This present invention generally relates to a catering method and more specifically to a busyness method using a novel website for multi-facility catering.

### BACKGROUND OF THE INVENTION

Catering to customers and third parties for breakfast, lunches and/or dinners means to remote sites traditionally was an extension of restaurant to-go and related services but has grown in a separate entity with the advent and evolution of website ordering methods.

One common method of providing catering services, includes an institution such as a school, geriatric facilities, prisons and other institutions, which have a large kitchen and employs a kitchen staff. The kitchen staff will be responsible for food processing and preparation but also must conduct tasks associated with food processing and preparation such as food storage, ordering materials, bookkeeping and accounting expenses, and cleaning and maintaining the kitchen facility. Many times the kitchen staff does not have the experience or time to conduct the associated tasks and other individuals must be hired to perform these activities.

Another method of catering usually centers around a single event such as weddings and various corporate parties, in which an catering business will prepare food, deliver the food and clean up the food areas of the event site. The main drawback of this method is that since is a occasional event, cost saving procedures such as volume food purchase and routine cooking procedures are not employed and thus this method is associated with a relatively high cost. This non-routine catering method is thus prohibitive due to the high cost such catering is typically is only available occasionally wedding and corporate events.

Another method of catering is an separate entity that organizes the processing, preparation, ordering and transport of food groups to multiple institutions and schools. This entity generally serves multiple meals to a number of institutions, thus splitting the cost of the catering business' kitchen facility and staff over a number of organizational customers such as smaller schools or the like. However, the weakness with this model is that since the food preparation facility is removed from the end customers, there is no real flexibility in terms of menu: the choice of food which is transported to the eating location (such as a smaller school) is the only choice available at the time of eating.

Due to numerous factors, schools, geriatric facilities, prisons and other institutions have difficulty offering a variety of menu choices, collecting feedback from patients, students, elderly clients, and other individuals to improve the quality of food items and prepared a greater variety of food choices. Pre-cooking food items usually results in producing excess amounts of food in order to offer multiple menu choices to each individual, thus increasing waste and subsequently and greatly increasing cost.

The present invention teaches a new model of catering which allows individuals to pre-order their desired menu from the catering organization. Thus the organization manages accounting, procurement, food preparation and so on, yet the individual customer has the option to pre-select their meal choice from a vastly diverse menu of choices.

### SUMMARY OF THE INVENTION

The present disclosure relates to a catering business that utilizes a website to manage individual food orders that are processed at one or more production kitchens strategically located near the target market. The catering business manages the production of food items, the delivery of food items that are maintained in portable ovens or warmers and/or active cooling, passive insulated or non-insulated containers that preserve the food items at safe temperatures for subsequent consumption. The catering business delivers the food items that can be stored in portable ovens or warmers and/or active cooling, passive insulated or non-insulated containers to various institutional or school locations for distribution by the particular institution school. The delivery of food items can be for breakfast, lunch and/or dinner meals. After the food is consumed, the delivery vehicles can return to the institutions to recover the portable ovens or warmers and/or active cooling, passive insulated or non-insulated containers for returning them to the particular one or more production kitchens. This process is repeated on a daily basis. It is also anticipated by the Applicants that disposable warmers or ovens and/or disposable active cooling, passive insulated or non-insulated containers can be used by the present business method invention which would eliminate the need to return the equipment to the institutions or schools. It is also anticipated by the Applicants that due to the differences in distance from the production kitchen and different institutions, and the associated delivery times, a combination a non-disposable and disposable warmers or ovens and/or active cooling, passive insulated or non-insulated containers can be used for the various institutions.

The associated website is designed to offer the customer several ways to order the food items for subsequent processing and delivery. Website screens, images, or pages first provide a means for the customer from a particular institution to create an ordering account. The ordering account includes such information as the customer or student names, order history, preferences and settings, and contact information. A second website screen allows for the adding or modifying a particular customer or student. The website allows several methods for ordering food items. One can start from an entree website page and select a desired entree which brings up another website page that provides a calendar signifying what days of the week or month this particular food item is offered. Food items are selected and then scheduled for preparation and delivery on a particular day of the week. Additional food items can be selected from these website screens to add other food items that are scheduled on days that were not selected. Another method to order the food items is by using a rolling calendar that is depicted on a website screen. The rolling calendar is superior over the standard Julian calendar by allowing a customer to enter into the calendar with the current week as the first row in the calendar, and subsequent weeks displayed below. This method allows for more days to be displayed on the ordering screen without displaying weeks that are in the past, but still in the current month. Whether order by the entree method or the calendar method, additional website screens provide the price and available portion size of the food item, nutritional facts and values of the food item, gluten, meat and dairy free indicators, and potential allergens. An additional method to order food items provided by specific website page is termed the easy order schedule. The easy order schedule relies on historical data from each customer or student to allow the automatic ordering of food items on days of the week pre-defined by the customer, based on the customer or student's defined taste preferences and/or ordering history.

When food orders are delivered to a particular institution, a daily report, that has been generated at the production kitchen, is provided with the food order to facilitate institutional workers or volunteers to have the proper information to process and distribute the daily order matching the particular food items to a particular customer or student.

Another website page allows the customer or student to rate the quality of the lunches and provide feedback.

The catering business method can include sending out ordering reminders on a regular basis to a registered email address, and a weekly order summary detailing the pre-ordered meals for the upcoming week. The upcoming week order summary provides a customer, student or family a means to plan for food lunches during the upcoming week or month.

### BRIEF DESCRIPTION OF THE DRAWINGS

FIG. 1 is a perspective view of a website screen or image that facilitates the management and administration of the customer, family or student.

FIG. 2 is a perspective view of a website screen or image that allow the addition or modification of customer or student information in a more detailed format.

FIG. 3 is a perspective view of a website screen or image that depicts a list of entrees available to a customer or student.

FIG. 4 is a perspective view of a website screen that shows a first method for ordering food items using the entree selection method.

FIG. 5 is a perspective view of a website screen that shows a second method for ordering food items using the rolling calendar selection method.

FIG. 6 is a perspective view of a website screen that shows an overview page of the selected item associated with the second method for ordering food items using the calendar selection method.

FIG. 7 is a perspective view of a website screen that shows a second method for ordering food items using the calendar selection method which includes information about nutritional facts and values of the food item.

FIG. 8 is a perspective view of a website screen that shows a second method for ordering food items using the calendar selection method which includes information about the allergens included in the food item.

FIG. 9 is a perspective view of a website screen allowing the customer or student to rate the lunches and provide feedback information to the catering business.

FIG. 10 is a perspective view of a first website screen that shows a third method for ordering food items for pre-defined days of the week using the easy order selection using historical data and preferences from the customer or student.

FIG. 11 is a perspective view of a second website screen that shows a third method for ordering food items using the easy order selection using historical data and preferences from the customer or student.

FIG. 12 is a perspective view of the present invention business catering method.

FIG. 13 is the first page of a flowchart depicting the steps in conducting the catering business method.

FIG. 14 is the second page of a flowchart depicting the steps in conducting the catering business method.

FIG. 15 is an example of the daily report that is prepared by the processing kitchens and sent with each delivery to an institution that facilitates the distribution of the food items to the correct individual.

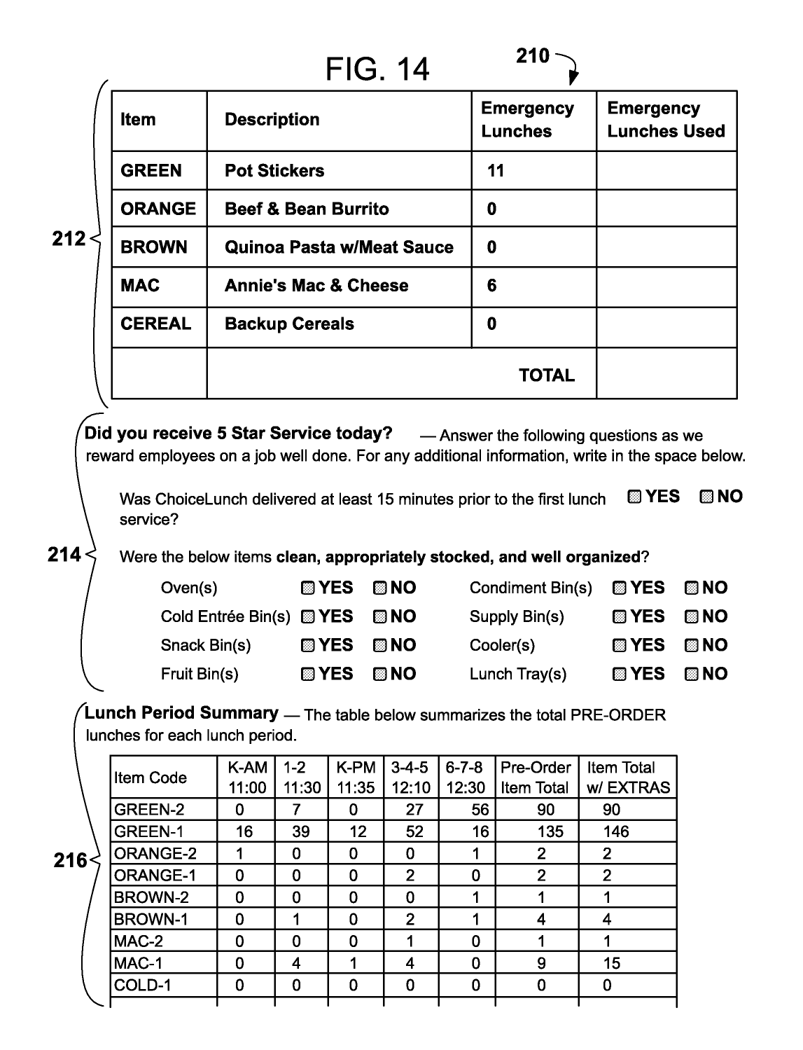

### DESCRIPTION OF THE PREFERRED EMBODIMENTS

Terms

The following is a glossary of terms used in the present application:

Customer—The customer refers to any individual who is associated with a contracted institution and includes, but is not limited to, parents, guardians and students.

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Personal computer (PC), smart phone, tablet, or similar computer device with internet capability includes all television with wired or wireless communication technology, remote cellular phones using channel access methods defined above (with cellular equipment, public switched telephone network lines, satellite, tower and mesh technology), mobile phones, PDAs, tablets (e.g. refers to all current and future variants, revisions and generations of the Apple IPAD, Samsung Galaxy, HP, Acer, Microsoft, Nook, Google Nexus, Sony, Kindle and all future tablets manufactured by these and other manufactures), Apple IPOD Touch, or a television, timepiece or fob watch and other similar apparatus with WIFI and wireless capability, and remote computers and controllers having internet or wireless connectivity.

Software Program or Instructions—the terms “software program” or “program” or “software instructions” are intended to have the full breadth of its ordinary meaning, and include any type of program instructions, code, script and/or data, or combinations thereof, that may be stored in a memory medium and executed by a processor. Exemplary software programs include programs written in text-based programming languages, such as .NET, C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output

GUI Elements

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output. Exemplary graphical user interface elements comprise input controls and output indicators

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at leas one processor that executes instructions from a memory medium and include desk top computer, laptop and ultra-top computers, computer tablets, smart phones and the computer like devices that have internet connection ability.

Exemplary Business Method Computer Network—Website

Preface—The website drawings and associated description are only examples of the present invention website and the Applicants' anticipate the various of the website drawings depicted can be modified to achieve the same objectives and purposes of the present invention website. For example, location of various information boxes, illustrations and soft buttons can be moved to other locations and achieve the same objectives and purposes of the present invention website. In addition, certain information boxes, illustrations or soft buttons can be associated with drop down boxes or pages and still achieve the same objective and purposes of the present invention website.

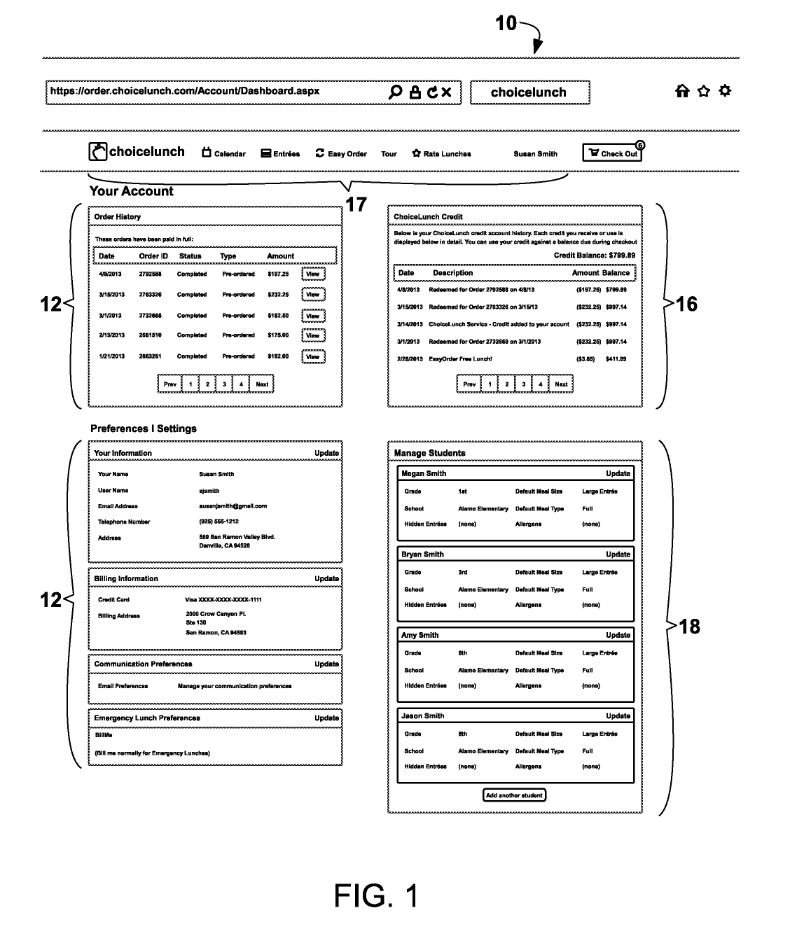

FIG. 1 is a perspective view of a website screen that facilitates the management and administration of the customer, family or student. The example website image 10 is encoded with program instructions and uses graphical user interfaces (GUI) to display the website image on a computer system. Shown in the example website screen or image 10 is an order history 12 which provides a review for a customer of the number and amount of orders placed in a multiple page format. In another GUI box of the website image 10 is the customer preferences and settings 14. This box 14 provides input boxes for customer (parent) name and address, billing information, communication preferences (email, phone text), and emergency lunch preferences (e.g. when parent forgets to order a lunch for a child on a particular day). Another GUI box 16 shows the credit information for including, but not limited to, promotional credits and credits for cancelled meals, for customers.

Individual students are managed in GUI box 18 where the students name, student's grade, institution (school), default meal size, default meal type, and hidden entrees are entered into the text enter box or GUI element areas. It is anticipated by the Applicants' that the format and location of the text boxes or GUI element can be modified with deviating from the purpose and design of the present invention website 10,

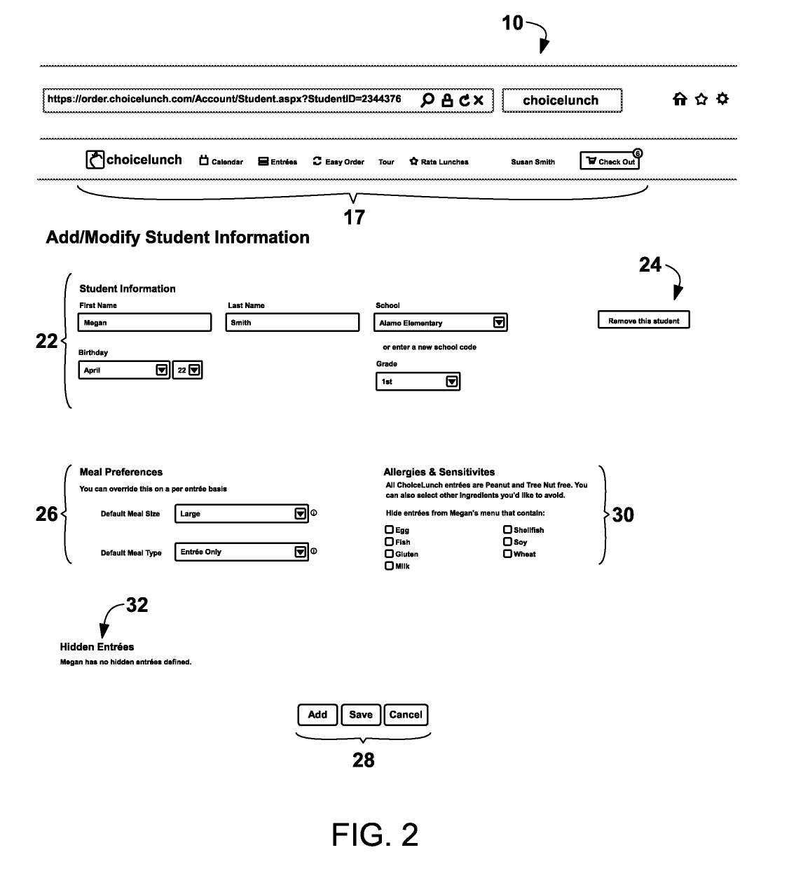

FIG. 2 is a perspective view of a website screen or image that allows the addition or modification of customer or student information in a more detailed GUI format 20. Characteristic of this and several other website screen or image, along the top of this website screen or image 20 is a series of soft buttons 17 that allow the user to select the three methods of ordering food items (rolling calendar, entree or easy order), provide a tour of the business methods website, rate lunches, check out, and lists the customer's/parent's name. The example website image 20 is encoded with program instructions and uses graphical user interfaces (GUI) to display the website image on a computer system, Shown is the enter text box or GUI element for the student first and last name with pull down box means for the institution (school), birth date and grade 22. The process of registering a family or customer associated with an institution can be accomplished by providing the family or customer with a specific institution code. Alternately the parent or customer can utilize a drop down menu that provides a listing of the registered institutions or input in a text box the name of a registered institution. It is also anticipated by the Applicants that websites with URLs dedicated to a specific company/registration institution can also be utilized. In selection GUI elements the website image 20 provides a pull down box means to enter the meal preference and meal type 26, and check boxes or GUI elements for allergies and sensitivities 30. Hidden entrees are shown in. GUI box 32. There is also a soft button for removing the student 24. Shown on the bottom of the web site screen or image 20 is GUI elements for saving cancelling or adding the information provided. It is anticipated by the Applicants' that the format and location of the text enter boxes or GUI elements can be modified, or some text enter boxes or GUI elements added or deleted, with deviating from the purpose and design of the present invention website screen or image 20.

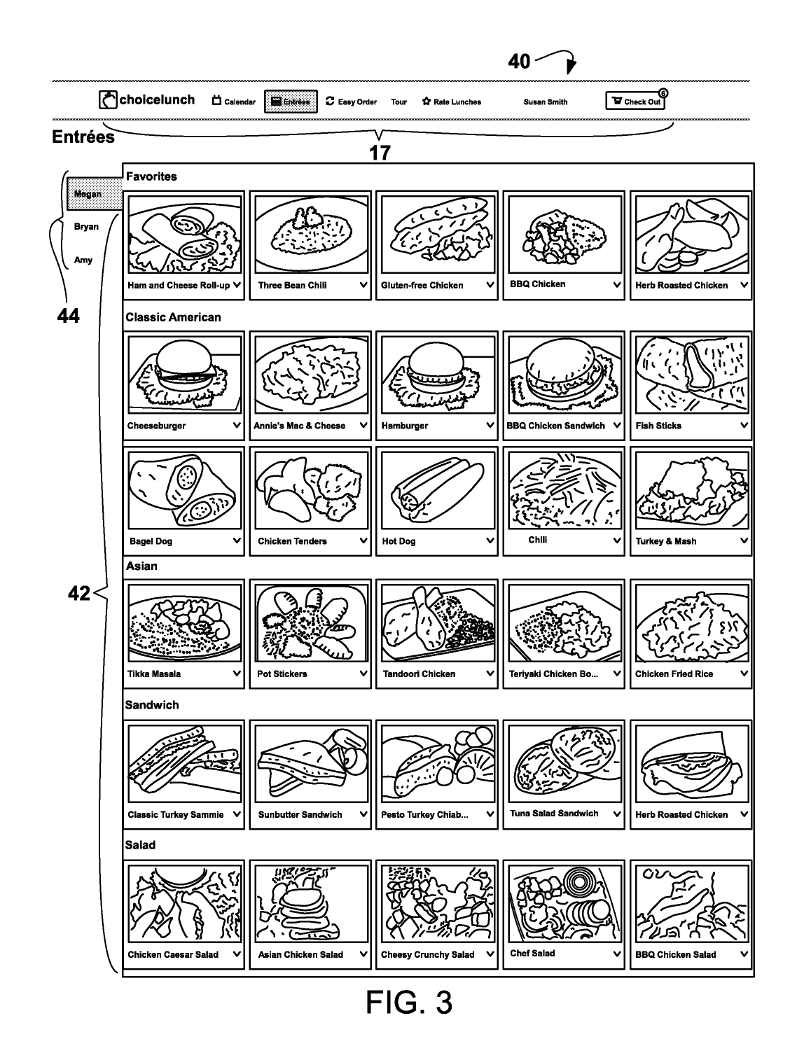

FIG. 3 is a perspective view of a website screen or image that depicts a customer or student's available entrees. Shown on this website screen or image 40 is a plurality of food items. Along the top of the website screen or image 40 is a series of soft buttons 17 that allow the user to select the three methods of ordering food items (rolling calendar, entree or automated order method), provide a tour of the business methods website, rate lunches, check out, and lists the customer's/parent's name. Shown along the top left location are the students names from a particular family with one student's name (Megan) highlighted 44. Megan's favorite meals are listed in a horizontal row next to her name. All of the other available food item entrees are shown 42 and segregated into food ethnic types. Shown on this example screen or image is classic American, Sandwiches, and Salads. There are numerous other food ethnic types such as Asian, Cool Munchies, Italian, Mexican, Sushi, and other ethnic food groups that are not shown on the website screen or image 40.

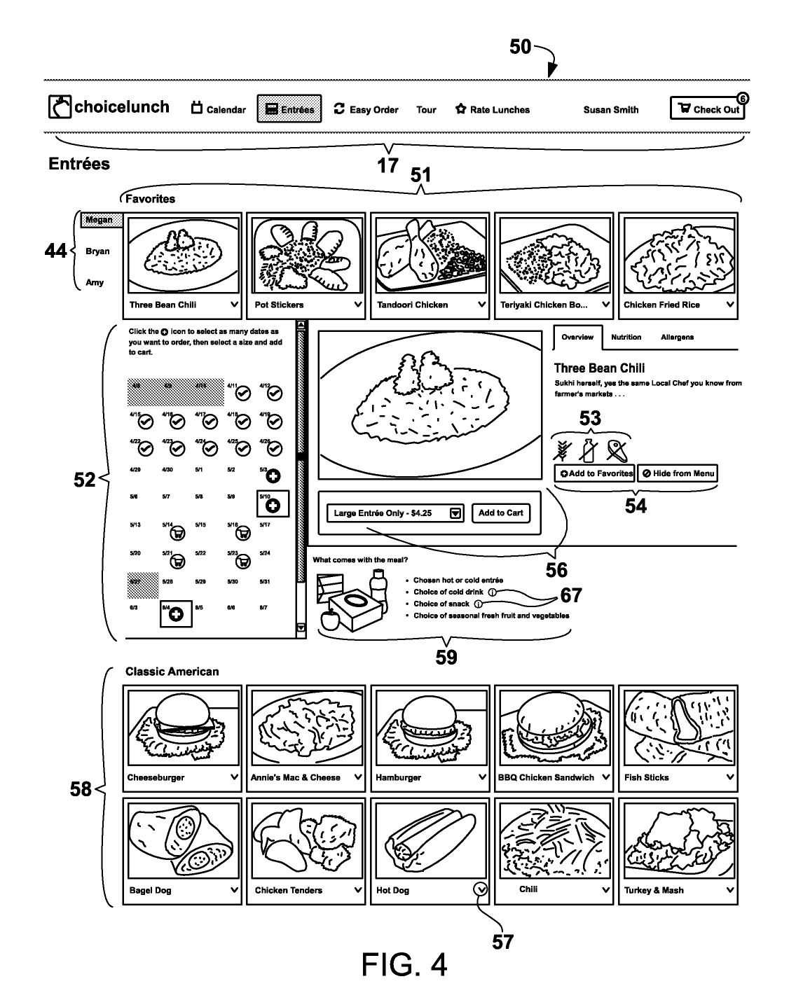

FIG. 4 is a perspective view of a website screen or image 50 that shows a first method for ordering food items using the entree selection method. This FIG. 4 is a follow up from website screen or image 40. When a food item is selected from website screen or image 40, then the website screen or image 40 appears in the GUI display. Along the top of website screen image 50 is a series of soft buttons 17 that allow the user to select the three methods of ordering food items (rolling calendar, entree or automated order method), provide a tour of the business methods website, rate lunches, check out, and lists the customer's/parent's name. Shown along the top left location are the students names from a particular family with one student's name (Megan) highlighted 44. The highlighted name associates all of that particular individual's favorite food items, allergens non-listed foods, preferred mean size and other specific information. Megan's favorite meals are listed in a horizontal row next to her name. Since the ethnic group selected in this example American (Three Bean Chili) 56, shown along the top is a horizontal series non-selected Asian foods 51, Since this is the entree food item selection method, a calendar is provided 52 which shows the rolling calendar day format and provides a means (e.g. check mark) to define what days food items have been pre-ordered and what days no food items have been ordered. For economical reasons, every food item is not available every day, hence some foods on only available on particular days. Hence on the calendar 52, GUI check marks are shown to indicate what days (dates) the selected food item 56 is available to order. The GUI for the check mark is changed in font, character mode or highlighted when the customer/parent/student selects/orders the food item. Item 53 provide icons that indicate the presence or non-presence of gluten, dairy or meat is incorporated in or part of the selected food item (shown as an illustrative icon with a crossed line). It is anticipated by the Applicants that the illustrative icon 53 could be shown in other formats, such as color format with, non-present gluten, dairy or meat shown in a red color and present gluten, dairy or meat shown in a green color. And the crossed line could be in the form of an X. Soft buttons 54 allow the customer user to add this food item to their favorite list or to hide this food item from the menu. In area 59 on this Figure, a listing of the additional items is shown (hot or cold entree, choice of a cold drink, snack fruit or vegetables). Soft buttons 67 provide pull down menus which provide a listing of the cold drinks or choice of snack available. Located at the bottom of FIG. 4 is a listing of other ethnic foods (Classic American) 58 that the customer user can select to order. Pull down soft buttons 57 can be utilized to this order selection or for other purposes. It is anticipated by the Applicants' that the format and location of the text enter boxes or GUI elements can be modified, or some text enter boxes or GUI elements added or deleted, with deviating from the purpose and design of the present invention website screen or image 50.

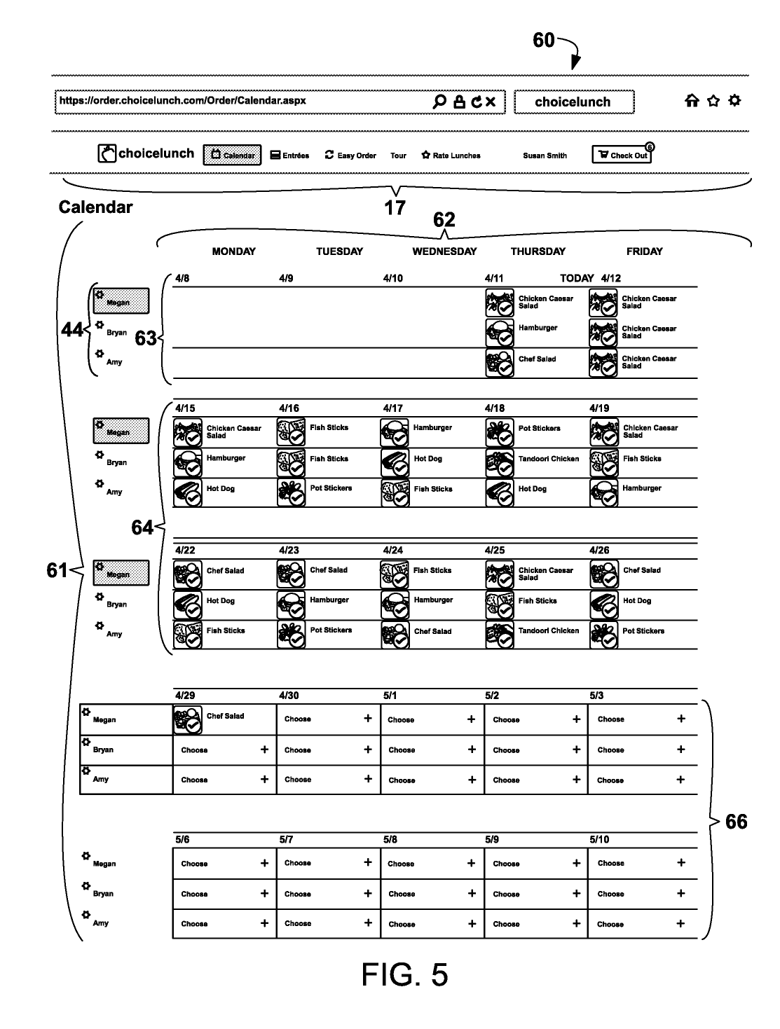

FIG. 5 is a perspective view of a website screen that shows a second method for ordering food items using the rolling calendar selection method. Along the top of website screen image 60 is a series of soft buttons 17 that allow the user to select the three methods of ordering food items (rolling calendar, entree or automated order method), provide a tour of the business methods website, rate lunches, check out, and lists the customer's/parent's name. Shown along the top left location are the students names from a particular family with one student's name (Megan) highlighted 44. The rolling calendar 63 is superior over the standard Julian calendar by allowing a parent or customer to enter into the calendar with the current week as the first row in the calendar, and subsequent weeks displayed below. This method allows for more days to be displayed on the ordering screen without displaying weeks that are in the past, but still in the current month. The current week 61 has the associated dates 62 displayed at the tap of the rolling calendar 63 and the available food items for the week, shown here as only Thursday and Friday (because theoretically in this example calendar method it is Wednesday). As shown only as an example in this website page 60, is the Chicken Caesar selected and pre-ordered for Megan, the Hamburger selected and pre-ordered for Bryan, and the Chef Salad is selected and pre-ordered for Amy on Thursday 4/11. These individual child food item selections continues for the example dates from 4/11 through 4/6. The listing of the students names (Megan) from a particular family with one student's name highlighted 44 are shown in subsequent weeks groupings 64 shown along the left side of the GUI website page 60. The subsequent weeks 64 have the associated dates displayed at the top of the rolling calendar 63 and the available food items for the each subsequent week 64. It is anticipated by the Applicants that the format and location of the text enter boxes or GUI elements can be modified, or some text enter boxes or GUI elements added or deleted, with deviating from the purpose and design of the present invention website screen or image 60.

Shown as 66 on website page 60 is additional as rolling calendar display weeks 4/29 though 5/10 where the selection process is incomplete. Only the Chef Salad for Megan has been selected and pre-ordered. No selections have been made for Bryan or Amy during the weeks starting from 4/29 through 5/10 as the Parent or Customer can make these selections any time one day prior to the delivery lunch date.

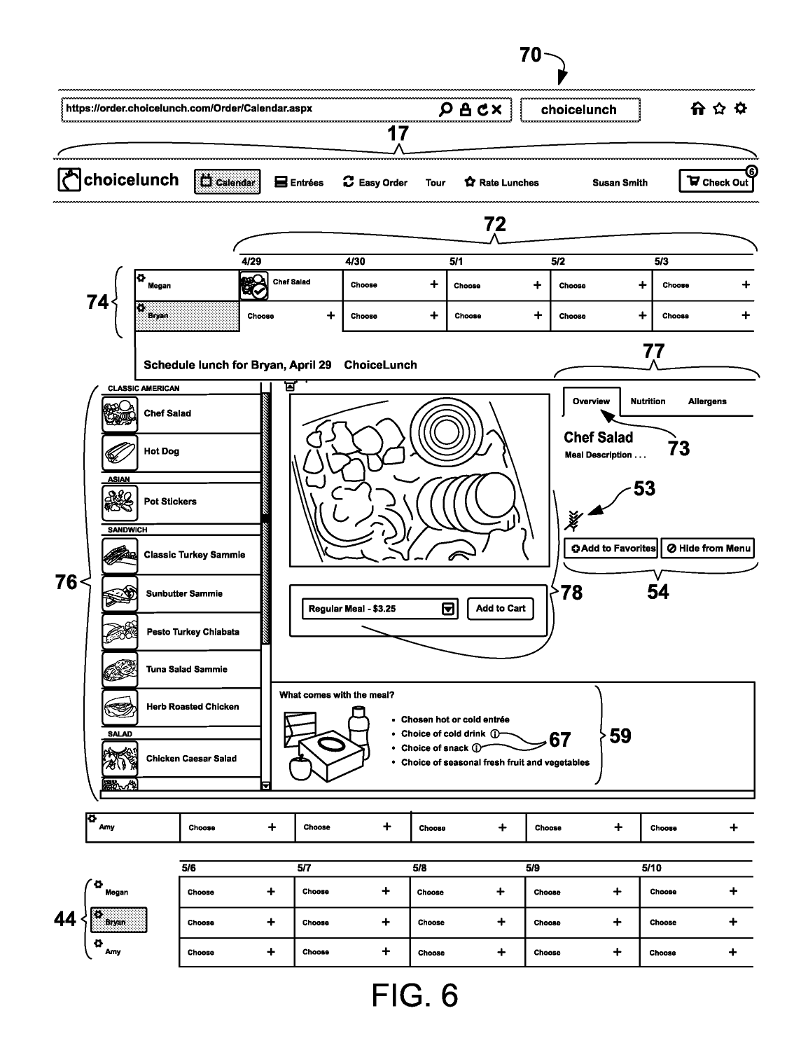

FIG. 6 is a perspective view of a website screen that shows an overview page 70 of the selected item associated with the second method for ordering food items using the calendar selection method. Along the top of website screen image 70 is a series of soft buttons 17 that allow the user to select the three methods of ordering food items (rolling calendar, entree or automated order method), provide a tour of the business methods website, rate lunches, check out, and lists the customer's/parent's name. In this example website page 70, a partial rolling calendar 72, show as a single week 4/29 through 5/3, located along the top of the GUI page. Shown along the top left location are the students names from a particular family with one student's name highlighted (Bryan) 74. The highlighted name associates all of that particular individual's favorite food items, allergens non-listed foods, preferred mean size and other specific information. Continuing down along the left side of the GUI overview website page 70 is a listing of other available food items 76 that can be selected and displayed on this GUI page 70 providing the food item details. In this example, the selected food item 78, Chef Salad, shows the size of the mean (Regular Size) and cost ($3.25) and a soft button to add the food item 78 to the pre-order cart. To the top right of the selected food item 78 is a soft button select menu 77 that changes the GUI website to the overview, nutrition or allergen pages and shows that the present page is the overview page 73. Show in a box below the selected food item 78 are items that are included with the food item 59. In this example, the included items 59 include a hot or cold entree, cold drink, snack, and seasonal fresh fruit and/or vegetables. Soft buttons 67 provide pull down menus which provide a listing of the cold drinks or choice of snack available. Shown to the right of the selected food item 78, is one or more icons 53 showing the inclusion of dairy, gluten or meat in the food item shown as an illustrative icon with a crossed line). It is anticipated by the Applicants that the illustrative icon 53 could be shown in other formats, such as color format with non-present gluten, dairy or meat shown in a red color and present gluten, dairy or meat shown in a green color. And the crossed line could be in the form of an X. In this example, gluten is excluded or not present in the meal. Dairy and meat are present in the meal. On the bottom of this example website page 70 are the students names from a particular family with one student's name (Megan) highlighted 44 for the subsequent week 5/6 through 5/10. The Applicant's anticipate that this overview page 70 can be utilized with the other ordering methods, e.g. the Entree Ordering Method and the Automated Order Method. Applicants' also anticipate that this example website 70 can rearrange the locations of the various items (44, 53, 54, 59, 72, 73, 74, 76, 77, and 78), text enter boxes or GUI elements, or add or delete some text enter boxes or GUI elements without deviating from the present invention website page 70.

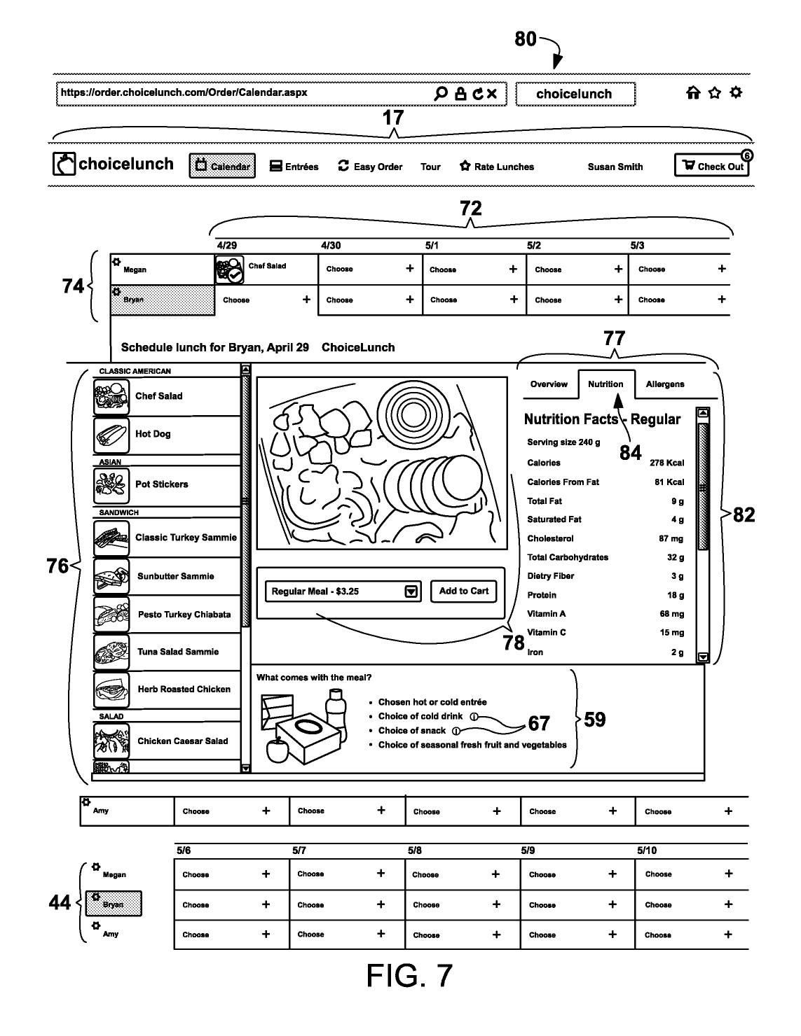

FIG. 7 is a perspective view of a website screen 80 that shows a nutritional page 80 of the selected item associated with the second method for ordering food items using the calendar selection method which includes information about nutritional facts and values of the food item. Along the top of website screen image 80 is a series of soft buttons 17 that allow the user to select the three methods of ordering food items (rolling calendar, entree or automated order method), provide a tour of the business methods website, rate lunches, check out, and lists the customer's/parent's name. In this example website page 80, a partial rolling calendar 72, show as a single week 4/29 through 5/3, located along the top of the GUI page. Shown along the top left location are the students names from a particular family with one student's name highlighted (Bryan) 74. The highlighted name associates all of that particular individual's favorite food items, allergens non-listed foods, preferred mean size and other specific information. Continuing down along the left side of the GUI overview website page 80 is a listing of other available food items 76 that can be selected and displayed on this GUI page 70 providing the food item details. In this example, the selected food item 78, Chef Salad, shows the size of the mean (Regular Size) and cost ($3.25) and a soft button to add the food item 78 to the pre-order cart. To the top right of the selected food item 78 is a soft button select menu 77 that changes the GUI website to the overview, nutrition or allergen pages and shows that the present page is the nutrition page 84. Show in a box below the selected food item 78 are items that are included with the food item 59. Soft buttons 67 provide pull down menus which provide a listing of the cold drinks or choice of snack available. In this example, the included items 59 include a hot or cold entree, cold drink, snack, and seasonal fresh fruit and/or vegetables. Shown to the right of the selected food item 78, is a listing of the nutritional facts 82 of the food item 78. On the bottom of this example website page 80 are the students names from a particular family with one student's name (Megan) highlighted 44 for the subsequent week 5/6 through 5/10. The Applicant's anticipate that this overview page 80 can be utilized with the other ordering methods, e.g. the Entree Ordering Method and the Automated Order Method. Applicants' also anticipate that this example website 80 can rearrange the locations of the various items (44, 53, 54, 59, 72, 73, 74, 76, 77, and 78), text enter boxes or GUI elements, or add or delete some text enter boxes or GUI elements without deviating from the present invention website page 80.

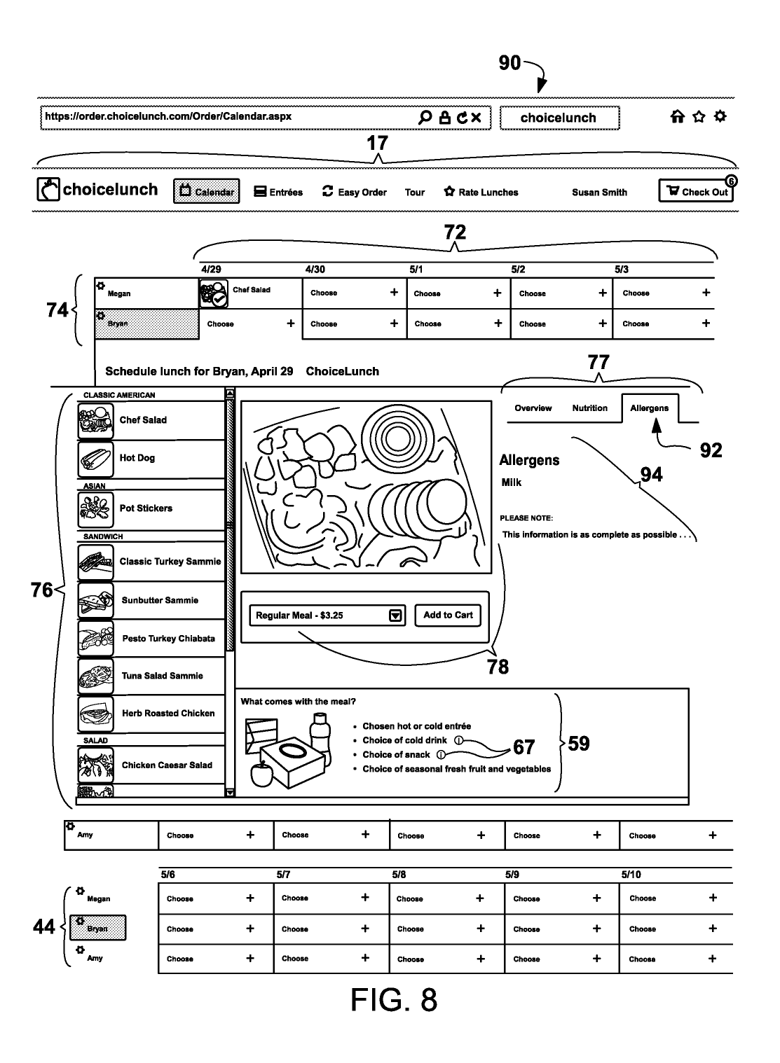

FIG. 8 is a perspective view of a website screen that shows a notice of allergens and sensitivities in the food item associated with the second method for ordering food items using the calendar selection method which includes information about the allergen and sensitivity potential in the food item. Along the top of website screen image 90 is a series of soft buttons 17 that allow the user to select the three methods of ordering food items (rolling calendar, entree or automated order method), provide a tour of the business methods website, rate lunches, check out, and lists the customer's/parent's name. In this example website page 90, a partial rolling calendar 72, show as a single week 4/29 through 5/3, located along the top of the GUI page. Shown along the top left location are the students names from a particular family with one student's name 74. Continuing down along the left side of the GUI overview website page 90 is a listing of other available food items 76 that can be selected and displayed on this GUI page 90 providing the food item details. In this example, the selected food item 78, Chef Salad, shows the size of the mean (Regular Size) and cost ($3.25) and a soft button to add the food item 78 to the pre-order cart. To the top right of the selected food item 78 is a soft button select menu 77 that changes the GUI website to the overview, nutrition or allergen pages and shows that the present page is the allergen page 92. Show in a box below the selected food item 78 are items that are included with the food item 59. In this example, the included items 59 include a hot or cold entree, cold drink, snack, and seasonal fresh fruit and/or vegetables. Shown to the right of the selected food item 78, is a listing of the potential allergens or sensitive ingredients 94 of the food item 78. The common allergens or sensitive ingredients 94 are milk, eggs, peanuts, tree nuts (e.g. almonds, cashews, walnuts), fish (e.g. bass, cod, flounder, salmon), shellfish (e.g. crab, lobster, shrimp), soy and wheat. On the bottom of this example website page 90 are the students names from a particular family with one student's name (Megan) highlighted 44 for the subsequent week 5/6 through 5/10. The Applicant's anticipate that this overview page 90 can be utilized with the other ordering methods, e.g. the Entree Ordering Method and the Automated Order Method. Applicants' also anticipate that this example website 90 can rearrange the locations of the various items (44, 53, 54, 59, 72, 73, 74, 76, 77, and 78), text enter boxes or GUI elements, or add or delete some text enter boxes or GUI elements without deviating from the present invention website page 90.

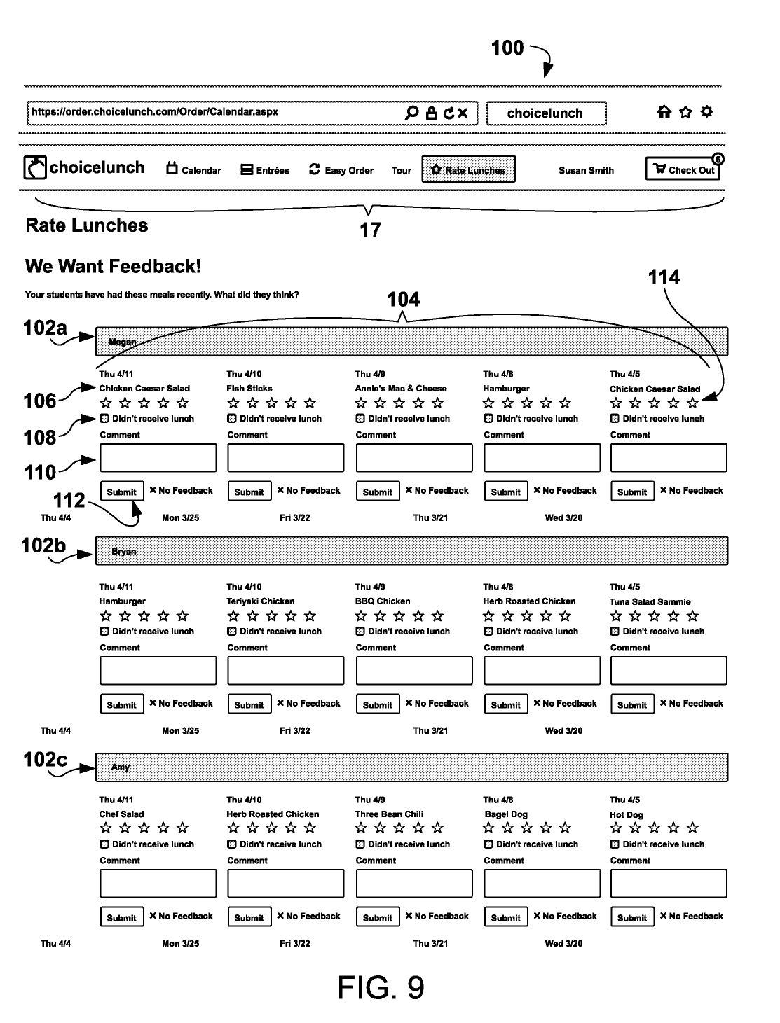

FIG. 9 is a perspective view of a website screen 100 allowing the customer or student to rate the lunches and provide feedback information to the catering business. Along the top of website screen image 100 is a series of soft buttons 17 that allow the user to select the three methods of ordering food items (rolling calendar, entree or automated order method), provide a tour of the business methods website, rate lunches, check out, and lists the customer's/parent's name. Listed are boxes with the students names highlighted (Megan 102a, Bryan 102b, and Amy 102c). The highlighted boxes can be color coded or have different graphic backgrounds for each student. Within in each box, is the food item selected 106, a soft button 108 that allows a parent or customer to check if a lunch was not received. A comment box for freestyle writing is provided in box 110. A soft icon star rating system 114 is provided to allow a parent or customer to simply select one of the stars to provide their rating. It is anticipated by the Applicants that various methods or inputting the star rating are available, such as clicking on the desired star rating and then the remaining stars are removed from the GUI image, or clicking on the star and the rating is color coded. A soft button submits the comments 112 to the company for analysis and review. Applicants' also anticipate that this example website 70 can rearrange the locations of the various items (102a,b,c, 106, 108, 110, 112, and 114), text enter boxes or GUI elements, or add or delete some text enter boxes or GUI elements without deviating from the present invention website page 100.

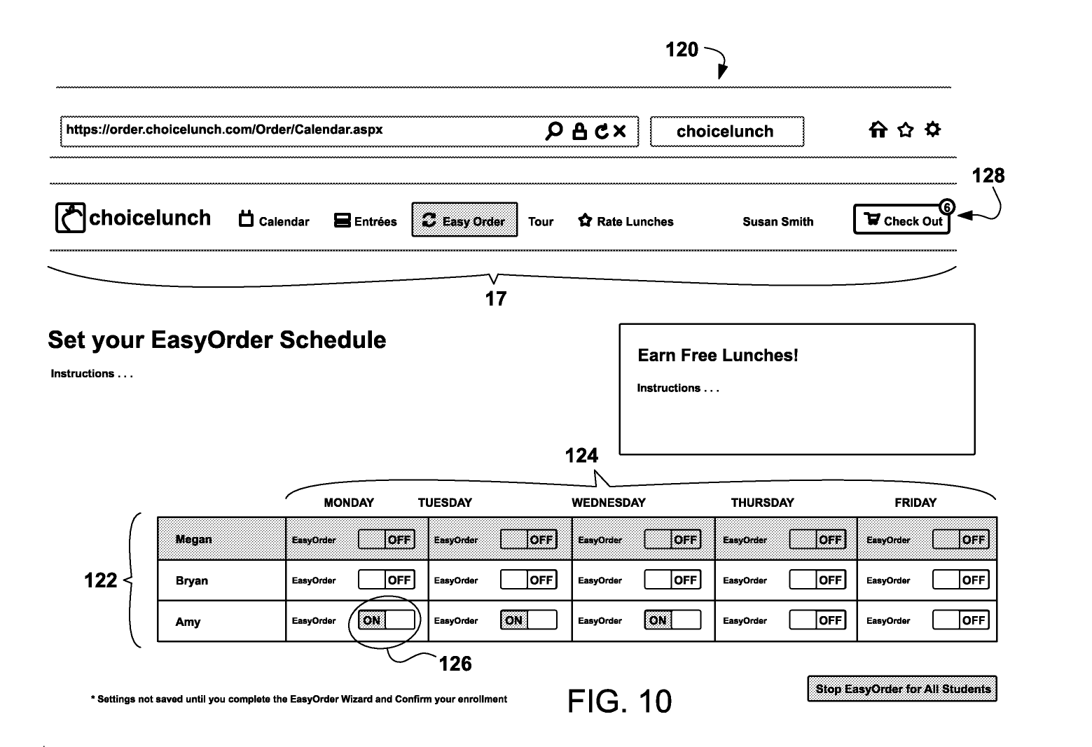

FIG. 10 is a perspective view of a first website screen 120 that show a third method for ordering food items using the automated order selection using historical data from the customer or student. The Automated Order Method uses historical data generated from each student and utilizes a mathematical algorithm to provide an easy, relative quick food item selection that the parent or customer can pre-order. Along the top of website screen image 120 is a series of soft buttons 17 that allow the user to select the three methods of ordering food items (rolling calendar, entree or automated order method), provide a tour of the business methods website, rate lunches, check out, and lists the customer's/parent's name. The automated order method provides a schedule in an spreadsheet format with the students 122 (Megan, Bryan and Amy) listed in the row format and the days of the current week 124 listing in a column format. Under each cell (student by day of the week) in a soft on/off button 126 or selecting the easy pre-order method for each student for a given day of the week. There is a check out soft button 128 that provides the customer or parents to enter the data for processing. Typically the customer or parent will have a pre-arranged credit card or PayPal account stored in a database with authorization for the automatic order method to debit for automatically ordered food items. It is anticipated by the Applicants' that the automated order method can change the locations of the various items (124, 126), the format of the items, format of the page (non-spreadsheet format) and use different means to select the easy pre-order e.g. single select button or add or delete some text enter boxes or GUI elements without deviating from the present invention website page 120.

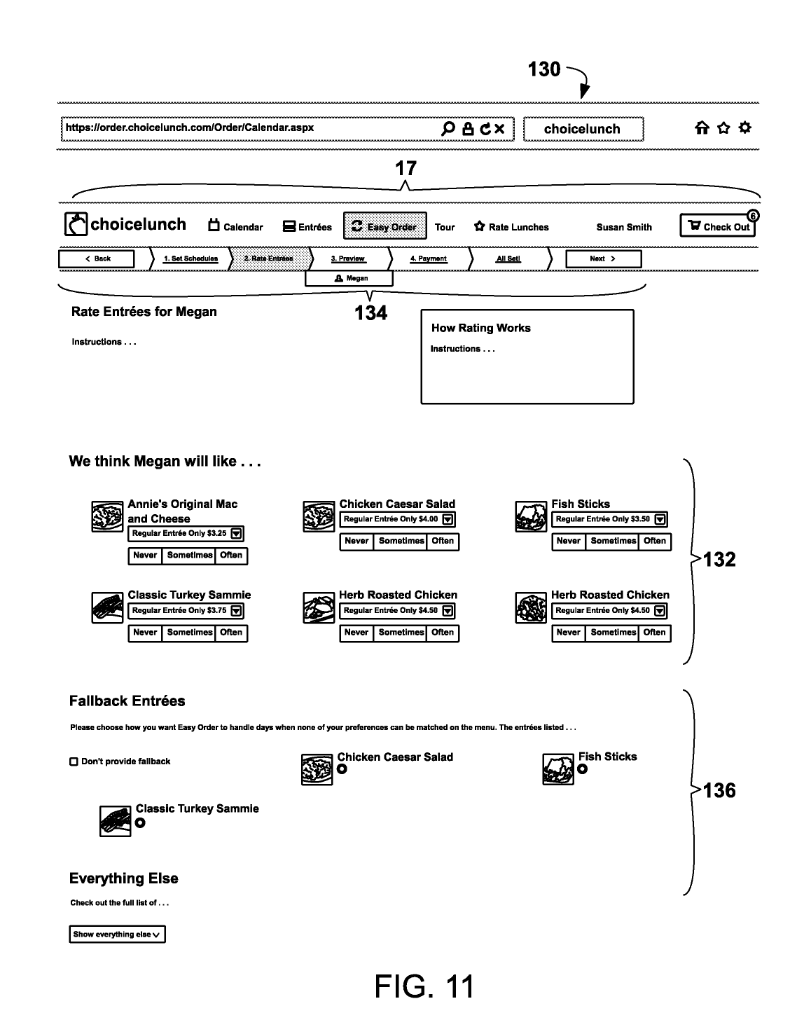

FIG. 11 is a perspective view of a second website screen 130 that show a third method for ordering food items using the automated order selection using historical data from the customer or student. Along the top of website screen image 130 is a series of soft buttons 17 that allow the user to select the three methods of ordering food items (rolling calendar, entree or automated order method), provide a tour of the business methods website, rate lunches, check out, and lists the customer's/parent's name. A so menu 134 provides the parent or customer to move between various pages such as set, schedules, rate entrees, preview orders, make payments, and provides back and next soft buttons. This website GUI page supplements the historical data and mathematical algorithm program by allowing the parent or customer to enhance the automated order selections by providing data for each student. In the supplement data boxes 132, for each student, the historical data and algorithm program lists food item selections that were generated by the program and provides the parent or customer to enhance the selection by choosing for each food item generated, to never, sometimes, or often selects a particular food item. As shown in the example website page, the parent or customer is provided a means 136 to select a fallback entree.

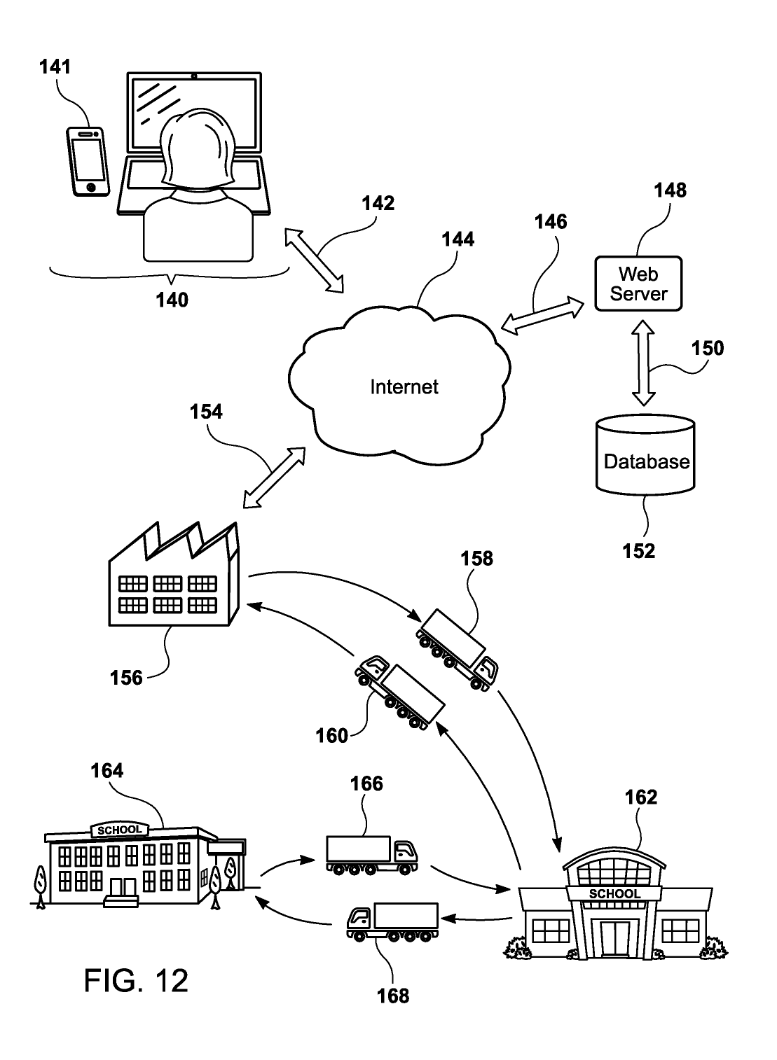

FIG. 12 is a perspective view of the present invention business catering method. Shown in FIG. 12 is a first symbol 140 that showing a parent or customer using a personal computer (PC), smart phone, tablet, or similar computer device with internet capability 141. The personal computer (PC), smart phone, tablet, mobile device or similar computer device with internet capability 141 is in wired or wireless communication 142 with the Internet 144. Connect by wired or wireless communication 146 is the web service operating by the company that communicates with database 152. The parent or customer accesses the present invention website using these internet entry to the web server and establishes an account that is associated previously has a registered institution.

The company or entity represented by symbol 156 manages the web server 148 and the database 152. The company or entity 156 also represents corporate offices that conducts marketing, accounting, customer complaints, document processing, food and provisions procurement, legal activities, software development and maintenance, and can provide delivery vehicles, storage and maintenance, and includes the regionally located preparation kitchens. Although not specifically shown in FIG. 12, the regionally located preparation kitchens will be strategically positioned in relatively close proximity to a series of institutions that will be serviced by the kitchens in order to facilitate the production and delivery of ordered food items to those serviced institutions. The regionally located preparation kitchens, must be responsible for, but not limited to, ordering supplies and items for food item production, maintain an experienced staff to prepare the food times, and maintain the cleanliness of the kitchen facilities. The regionally located preparation kitchens communicate 154 with the company or first entity web servers software to process orders made on a daily schedule. It is anticipated by the Applicant's that the regionally located preparation kitchens can be owned and maintained by the company or can be owned and maintained by a second entity. Communication, planning and coordination of activities between the company and the second entity will be necessary. Symbol 158 depicts the daily delivery of pre-ordered food items to specific a first school/institution 162. Symbol 168 represents that the delivery vehicle can leave at first school/institution 162 and continue to make additional deliveries to one or more schools/institutions represented by symbol 164. It is anticipated that the delivery vehicles 158 depicted FIG. 12 can be company owned or leased, individual owned, institution owned or leased, or owned and maintained by the company, the second entity or a third entity, and any combination of ownership. Communication, planning and coordination of activities between the company, the second entity, or third entity will be necessary to organize and synchronize food preparation and delivery to the institutions are ordered by parents and customers. The maintenance of delivery vehicles includes, but is not limited to, providing fuel and oil supplies, maintain a driver staff, provide parking facilities, and maintain the cleanliness of the vehicles. Since the delivery vehicle can utilize conventional non-disposable oven/warmers and/or active cooling, passive insulated or non-insulated containers to maintain the various food items, symbols 166 and 160 represent the delivery vehicles returning to the one or more schools/institutions to recover the non-disposable ovens/warmers and/or active cooling, passive insulated or non-insulated containers to be used again. It is anticipated by the Applicants' that the recovery of the non-disposable ovens or warmers and/or active cooling, passive insulated or non-insulated containers bins can be retrieved by the delivery vehicles return route the same day, retrieved by the delivery vehicles on the next delivery day, or retrieved in any future date as the non-disposable oven/warmers can be leased rented or loaned to the intuitions for a time period. It is also anticipated by the Applicants' can utilized disposable ovens or warmers and/or disposable active cooling, passive insulated or non-insulated containers and therefore the return recovery operations would not be necessary.

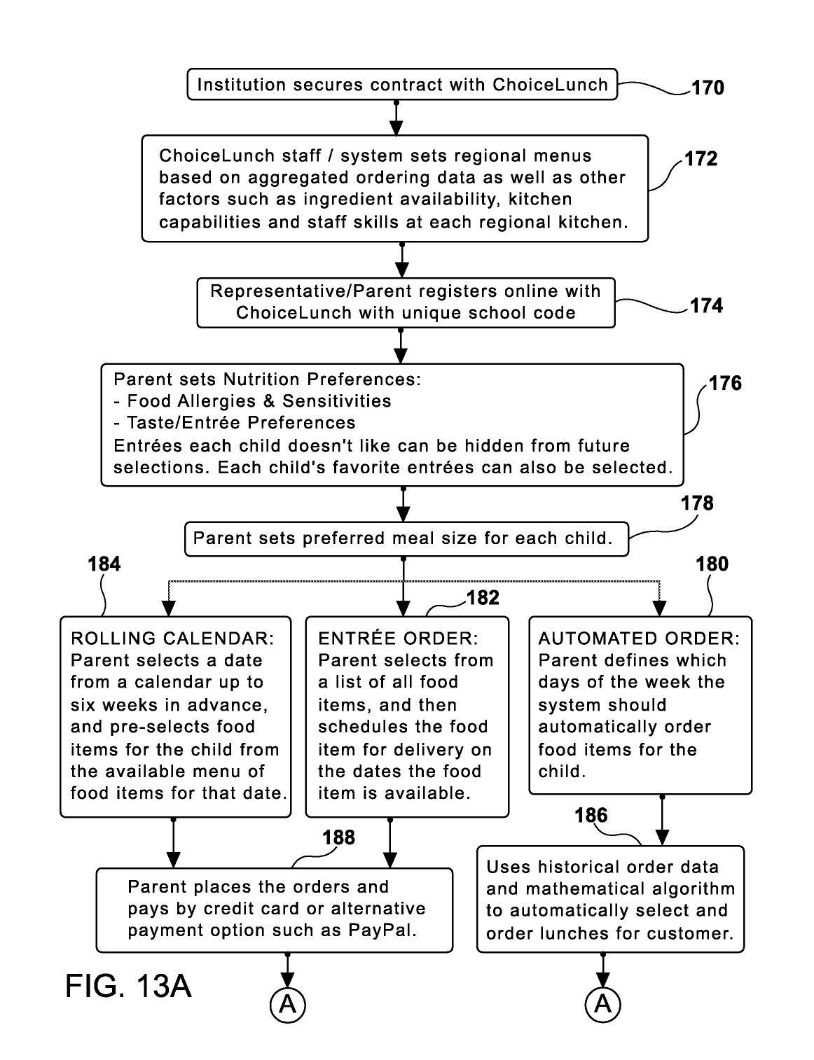

FIG. 13A is the first page of a flowchart depicting the steps in conducting the catering business method. Step 170 demonstrates that one of the first requirements in the catering business method is establishing a contract with an institution or school. The company's staff then sets regional menus based on aggregate ordering data as well as other factors such as ingredient availability, kitchen capabilities and staff skills 172. Representative of the company are responsible for coordinating these activities and once an institution or school is registered, parents or customers associated with the registered institution or school can register on-line with the company using a unique institution or school code as shown in step 174. At this point, the website displays a “Order Now” page which allow an individual to create an account, enter a institution/school code, and login in to their account. Once the parent or customer is registered, they can set begin to provide specific information for their children (as shown in FIG. 1), such as their name, grade in school, entree preferences, nutritional and taste preferences, and food allergies and sensitivities (step 176). As shown in step 176, entrees each child doesn't like (or parent's that do not desire specific entrees for their children) and each child's favorite entrees can be defined and selected. Shown in step 178, the parent or customer also set the meal size for each child as the company offers various meals sizes recognizing that children of different sizes and ages have different caloric needs or desires. Unique to the present invention catering website is that every parent or customer is provided two or more methods to order food for their children. Shown in step 184 is the rolling calendar food ordering method. The rolling calendar 63 is superior over the standard Julian calendar by allowing a parent or customer to enter into the calendar with the current week as the first row in the calendar, and subsequent weeks displayed below. This method allows for more days to be displayed on the ordering screen without displaying weeks that are in the past, but still in the current month (as shown in more detail in FIG. 5 and the accompanying description). Step continues with step 188 whereby the rolling calendar order method allows the parent or customer to place an food orders and pays by credit card or uses an alternate payment method such as PayPal.

Shown in step 182 is the website alternative entree order method. Step 182 is shown in more detail in FIGS. 3 and 4 and the accompanying description. Parents or customers also can select back-up entree preferences for each child should certain entrees become unavailable for any given day. Step 182 continues to step 188 whereby the entree order method allows the parent or customer to place a food orders and pays using traditional methods, credit card, Paypal, or other methods such as established accounting and billing practices.

Shown in step 180 is the alternate automated order method whereby can determine what day of the week the parent or customer desires to utilized this services. The automated order method (shown in more detail in FIGS. 10 and 11 and the accompanying description) uses historical order data for each child and a mathematical algorithm to automatically select lunches for a child an particular days (Step 186). In the automated order method, the parent or customer has a credit card or PayPal account registered with the Company who has been granted authorization to automatically make charges to the credit card, Paypal, or other methods such as established accounting and billing practices when easy orders are made by the parent or customer.

Referring now to FIG. 13B, which is a continuation of FIG. 13A, the three order methods, the rolling calendar order method 184, 188, the entree order method 182, 188, and the automated order method 180, 186, coalesce into step 190 which show another unique feature of the present invention website software system which utilizes software instructions that are client specific to automatically filter and eliminate: entrees based on each student's taste preference and food allergies and sensitivities.

As demonstrated in step 192, early each day, the company aggregates all the pre-orders and separates these orders into schools which are serviced by regional production kitchens. This is further augmented in step 192 whereby the company staff and/or system determines regional menus based on the aggregation ordering data, ingredient and food items availability, kitchen capabilities, staff skills and other factors at each regional kitchen. Once these details and information is processed, the company sends the food orders to each regional kitchen (step 194). The regional production kitchens then prepares the ordered food items each day and then using company owned vehicles delivers that food items to each school with the necessary equipment to maintain the integrity of the food items (step 196). Non-disposable or disposable ovens and warmers are used to maintain the hot meals and insulated coolers for non-heated items.

Step 198 is an alternate method whereby after delivering the food items, the delivery vehicles, after lunch time, cycle back to the institutions or schools to retrieve the heating or warming equipment and/or active cooling, passive insulated or non-insulated containers. The delivery vehicles then return to the regional production kitchens to return the heating or warming equipment and/or active cooling, passive insulated or non-insulated containers (step 200). The delivery vehicles can retrieve the heating or warming equipment and/or active cooling, passive insulated or non-insulated containers the following day when new orders are delivered, or retrieved in any future date as the non-disposable oven/warmers can be leased/rented or loaned to the intuition for a time period. Steps 198 and 200 are considered an alternate method because the company can use disposable heating or warming equipment and/or active cooling, passive insulated or non-insulated containers that are simply thrown away each day. If the heating or warming equipment and/or active cooling, passive insulated or non-insulated containers are not disposable, then steps 204 and 206 are necessary. The use of non-disposable heating or warming equipment and/or active cooling, passive insulated or non-insulated containers, such as those used by the fast food industry have traditionally used materials (styrene cups, plastic ice packs) that are not conscious of resources and not environmentally sensitive. However, biodegradable containers are becoming more widespread and the Applicants anticipate that some or all of the heating or warming equipment and/or active cooling, passive insulated or non-insulated containers might be disposable.

It is anticipated by the Applicants that a single company or entity can own and manage the unique and novel website service, the kitchen facilities and the daily food delivery. Other services that the company can manage includes, but is not limited to, ordering materials and food for the kitchen facilities, maintaining the cleanliness of the kitchen facilities, purchasing/leasing/renting the delivery vehicles and maintaining the delivery vehicles, arranging the delivery schedules, processing orders from the website, processing customer comments and complaints, accounting and insurance services, and novel website updates, modifications and maintenance. It is also anticipated that more than one company or entity can own and manage the various services described. For example, the accounting, customer comments processing and website services and order processing can be managed by one company/entity, and the food production at the kitchen facilities, maintenance of the kitchen facilities, material and food ordering and food delivery can be managed by another company entity. This is just one example as many different combination of services and responsibilities can be managed by one or more companies or entities. However separated, there must be adequate communication between the companies/entities to fulfill the ultimate goal of providing food services to institutions using the novel website ordering process.

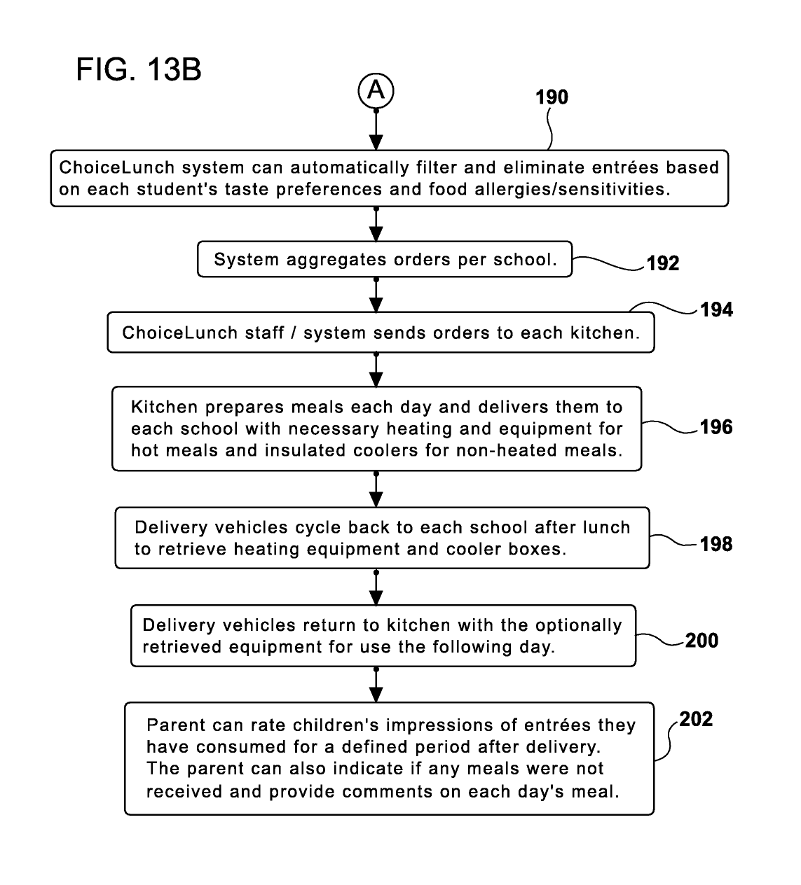

FIG. 14 is an example of a daily food summary report that is generated by the company (usually at each regional production kitchen). This daily food summary report is sent with each delivery to an institution or school and facilitates the distribution of the food items to the correct individual. As shown in the example website page, the daily food summary report can include a tally 212 of emergency food items and the number of these emergency food items by category. The daily food summary also provides a means for the institution or school officials to rate the timing of food delivery and cleanliness and organization of the maintenance equipment 214. The daily food summary also includes a summary of the pre-ordered food items and defines the distribution of the food items to the various school grades 216.

Not shown specifically in the Figures but anticipated by the Applicants is the email communication and confirmation of an food order can be sent to the each parent, customer or student every day an pre order is made. It is also anticipated by the Applicants that a weekly or monthly upcoming schedule can be sent by email or other means (e.g. regular mail) so that parents or customers can have a food schedule that can be place in a convenient location (e.g. on the refrigerator).

Thus, specific embodiments and applications of a catering business method with a novel website have been disclosed. It should be apparent, however, to those skilled in the art that many more modifications besides those already described are possible without departing from the inventive concept herein. The inventive subject matter therefore, is not to restricted except in the spirit of the claims. Moreover, in interpreting both the specification and the claims, all terms should be interpreted in the broadest possible manner consistent with context. In particular, the terms “comprises” and “comprising” should be interpreted as referring to elements, components, or steps in a non-exclusive manner, including that the reference elements, components, or steps may be present, or utilized, or combined with other elements, components, or steps that are not expressly referenced. Furthermore, where a definition or use or a term in a reference, which is incorporated by reference herein is inconsistent or contrary to the definition of the term provide herein, the definition term provided herein applies and the definition of the term in the reference does not apply.

1. A company sponsored catering method for individual customers associated with an registered institution with which the individual customers are associated, the catering method comprising the steps of:
establishing a contractual relationship between a catering company and an institution, said institution having a plurality of customers;
said plurality of customers registering with said catering company providing individual profile information and payment information;
upon registration, said plurality of customers are provided access to the company sponsored website;
said company sponsored website designed to allow the ordering of food items;
said company sponsored website allow the ordering of food items using one or more ordering methods;
a first alternate method for ordering food items using a rolling calendar method;
a second alternate method for ordering food items using an entree selection method;
a third alternate method for ordering food items using an automated ordering method;
upon receiving orders for food items, said catering company prepares said food items at a plurality of processing kitchens strategically located near said institutions; and
said catering company delivers said food items to one or more institutions.

2. The catering method according to claim 1, whereby said delivery of food items utilizes portable ovens or warmers and/or active cooling, passive insulated or non-insulated containers to maintain the integrity of the food items for a period of time.

3. The catering method according to claim 1, whereby said delivery of said food items includes a daily report to each institution or school which details food item information of each delivery which is designed to facilitate the distribution of food items to the customers.

4. The catering method according to claim 1, further comprising said company sponsored website provides a nutritional fact statement for each food item.

5. The catering method according to claim 1, further comprising said company sponsored website provides icons in close proximity to a food item showing the presence of common allergens and sensitivities.

6. The catering method according to claim 1, further comprising said company sponsored website filters for and restricts food items that have potential allergens and sensitivities that are reported by customer.

7. The catering method according to claim 2, wherein said catering company retrieves said portable warmers or ovens and/or active cooling, passive insulated or non-insulated containers for a period of time after delivery to said institutions.

8. The catering method according to claim 1, wherein said catering company sends an electronic message comprising a confirmation of food items ordered to each customer.

9. The catering method according to claim 1, wherein said catering company sends an electronic message comprising a prospective schedule of weekly or monthly ordered food items to each customer.

10. A multi-entity sponsored catering method for individual customers associated with a registered institution with which the individual customers are associated, the catering method comprising the steps of:
establishing a contractual relationship between a first entity and an institution, said institution having a plurality of customers;
said plurality of customers registering with said first entity providing individual profile information and payment information;
upon registration, said plurality of customers are provided access to the first entity sponsored website;
said first entity sponsored website allow the ordering of food items by one or more ordering methods;
a first alternate method for ordering food items using a rolling calendar method;
a second alternate method for ordering food items using an entree selection method;
a third alternate method for ordering food items using easy order method;
upon receiving and processing orders for food items, said first entity communicates the food orders to a another entity;
upon receiving orders for food items, a second entity prepares said food items at a plurality of processing kitchens strategically located near said institutions; and
said first, said second or a third entity delivers said food items to one or more institutions.

11. The catering method according to claim 10, whereby said delivery of food items utilizes portable ovens or warmers and/or active cooling, passive insulated or non-insulated containers to maintain the integrity of the food items for a period of time.

12. The catering method according to claim 10, whereby said delivery of said food items includes a daily report to each institution or school which details food item information of each delivery which is designed to facilitate the distribution of food items to the customers.

13. The catering method according to claim 10, further comprising said company sponsored website provides a nutritional facts for each food item.

14. The catering method according to claim 10, further comprising said company sponsored website provides icons in close proximity to a food item showing the presence of common allergens and sensitivities.

15. The catering method according to claim 10, further comprising said company sponsored website filters for and restricts food items that have potential allergens and/or sensitivities that are reported by customer.

16. The catering method according to claim 11, wherein said catering company retrieves said portable ovens or warmers and/or active cooling, passive insulated or non-insulated containers for a period of time after delivery to said institutions.

17. The catering method according to claim 11, wherein said catering company sends an electronic message comprising a confirmation of food items ordered to each customer.

18. The catering method according to claim 11, wherein said catering company sends an electronic message comprising a prospective schedule of weekly or monthly ordered food it each customer.

19. A catering business method website comprising of several modules,
whereas a first administrative module is designed to record customer information into a database and establishing a customer registration that enables the customer to enter other modules of said website;
whereas a second module is designed to allow a customer to order food items by one or more ordering methods;
whereby a first alternate method for ordering food items using a rolling calendar method that creates a schedule of orders for each customer's registered institution;
whereby a second alternate optional method for ordering food items using an entree selection method creates a schedule of orders for each customer' registered institution;
whereby a third alternate optional method for ordering food items using automated method creates a schedule orders for each customer's registered institution;
whereas said schedule is recorded into a database that has software instructions for processing a daily schedule of food orders,
whereas a payment module it integrated with the daily schedule and charges customers for individual food items ordered, and
whereas said daily schedule contains information that is transferred to one or more food processing centers.

20. A catering business method website according to claim 19 further comprising a module that schedules delivery of food items to said institutions.
